(19) United States
(12) Patent Application Publication
(10) Pub. No.: US 2004/0042512 A1
(43) Pub. Date: Mar. 4, 2004

(54) Method and apparatus for production of entangled states of photons

(76) Inventors: Antia Lamas-Linares, Oxford (GB); John C. Howell, New York, NY (US); Dik Bouwmeester, Oxford (GB)

Correspondence Address: NIXON & VANDERHYE, PC, 1100 N GLEBE ROAD, 8TH FLOOR, ARLINGTON, VA, 22201-4714, US

(21) Appl. No.: 10/228,285

(22) Filed: Aug. 27, 2002

(51) Int. Cl. H01S 3/10

(52) U.S. Cl. 372/21

(57) ABSTRACT

A method and apparatus for enhancing the production of polarisation-entangled multiphoton states from a laser pumped parametric down-converting crystal. The pump beam and initial down-converted photons are returned by retro mirrors, in phase to the down-converting crystal where they stimulate the emission of further polarisation-entangled states. The efficiency of the process is increased by including in the path of the returning down-converted photons a crystal of the same substance and thickness as the down-converting crystal to provide spatial and temporal walk-off compensation. Further, the phase of the returning pump beam is adjusted and optimised by control of the retro-mirror while monitoring the rate of production of polarisation-entangled photon pairs. Maximising the rate of production of photon pairs also maximises the rate of production of higher-order states, such as four-photon states.

### BACKGROUND OF THE INVENTION

The present invention relates to the production of entangled states of quantum particles.

Over the past few years experiments on the production of entangled states of quantum particles have illustrated many of the remarkable counter-intuitive aspects of quantum behaviour, such as non-locality. More recently useful applications of such entangled state have been explored, including cryptography, communications, quantum teleportation and quantum computation.

“Entanglement” means that the states of two or more quantum particles are inter-related, despite their physical separation. Thus rather than separate, local, descriptions of their states, there is a single description of the state of the particles and a measurement on one of them provides information about the others. When considering entangled quantum particles one or more of the particle's properties (such as linear momentum, angular momentum etc) may be “entangled”. One practical problem with entangled particles is that as they interact with the environment, the entanglement is lost. Some particles are worse in this respect than others. Photons for example interact weakly with the environment, and so it is easier to maintain an entangled state of one of their properties, such as polarisation. Interest has increased, therefore in producing polarisation-entangled photons.

A way of producing polarisation-entangled photon pairs using parametric down-conversion is disclosed in “New High-Intensity Source of Polarisation-Entangled Photon Pairs” by Paul G Kwiat et. al in Phys. Rev. Letters, Volume 75, Number 24, Dec. 11, 1995. The arrangement is shown in FIG. 1 of the accompanying drawings. A 150 milliwatt pump laser beam L at a wavelength of 351.1 nm from a single-mode Argon ion laser is used to illuminate a beta-barium borate (BBO) crystal 1. A parametric down-conversion process occurs in the BBO crystal in which a photon in the pump beam is converted into a pair of lower frequency photons which have entangled polarisation states and propagate in different directions along the two beams 3 and 5. In FIG. 1 extra birefringent crystals C1 and C2, along with a half wave plate HWP0 are used to compensate the birefringent walk-off effects from the production crystal. In other words, because the BBO crystal is birefringent, the two down-converted photons, which correspond to the ordinary and extraordinary rays, propagate in slightly different directions and slightly different speeds. In order to preserve quantum entanglement it is necessary that the two photons are indistinguishable and the half wave plate HWP0 and crystals C1 and C2 effectively exchange the polarisation states thus introducing this indistinguishability. This is the well-known technique of quantum erasure. The half wave plate HWP1, quarter wave plate QWP1, narrow band filters of 1 and 2 and polarisers P1 and P2 are effective to allow detection of the different entangled states produced in the BBO crystal.

A problem with the apparatus with FIG. 1, however, is that the parametric down-conversion process has a low efficiency and thus the number of photon pairs produced is low. For use in practical applications, it would be useful to increase the intensity of photons produced.

A development of the apparatus was proposed in “Interference Enhanced Polarisation Entanglement and the Concept of an Entangled-Photon Laser” by Antia Lamas-Linares et. al. (archiv: quant-ph/0103056v1, Mar. 12, 2001) illustrated in FIG. 2. In this apparatus the pump laser beam L illuminates the BBO parametric down-converting crystal 1 as before, but the laser pulse is reflected back into the crystal 1 by means of the mirror M3. Similarly, the down-converted photons are also fed back into the BBO crystal 1 by means of mirrors M1 and M2. The pinholes p are effective to select the entangled states and the BBO crystals 4 and narrow band filters f1 and f2 in the detection stages D1 and D2 complete the birefringence and temporal walk-off compensation.

In FIG. 2 the half wave plate 2 is included to exchange the horizontal and vertical field component thus ensuring that each photon experiences the same birefringence and spatial walk-off. Thus, as in the FIG. 1 arrangement, this guarantees the indistinguishability of photons created in the amplification process. The reintroduction of the down-converted photons in the BBO crystal 1 in correct phase with the returning laser pulse from the mirror M3 results in a stimulated emission process in which further down-converted photons are produced. This stimulated emission process therefore increases the number of entangled states produced. Thus the arrangement in FIG. 2 can be regarded as operating in similar fashion to a laser, except that rather than producing merely coherent light, it produces polarisation-entangled photons. The amplification process is, however, dependent upon achieving the correct phase between the returning pump pulse from mirror M3 and the returning down-converted photons. FIG. 3 illustrates how the number of photon coincidences at detectors Dl and D2 depends upon the mirror position. It can be seen that in the illustrated example a maximum number of photon coincidences (i.e. entangled photon pairs) was produced with a mirror position of approximately 160 to 170 microns. In fact if one looks more closely it can be seen from FIG. 4 that the amplification is actually an inference effect and that in the region of maximum response the coincidence rate oscillates with a period corresponding to half the wavelength of the pump field. Therefore the adjustment of the instrument, in this case the position of the mirror M3, is critical to the amplification process.

Typically regarded as an additional problem is the generation of higher-order modes consisting of more than two entangled photons. The intensity of such modes is relatively low, and too low to be useful, and they have been regarded as noise which cause difficulties in practical applications.

### SUMMARY OF THE INVENTION

An object of the invention is to increase the efficiency of the amplification process. A further object of the invention is to increase the intensity of higher-order modes such that such higher-order modes have a sufficient intensity to be practically useful.

A first aspect of the invention provides a method of producing a polarisation-entangled multiphoton light field comprising illuminating a parametric down-converting crystal with a pumping light beam, reflecting the down-converted light field back to the parametric down-converting crystal using first reflectors, reflecting the pumping light beam back to the parametric down-converting crystal using a second reflector, detecting multiphoton coincidences in photons emitted from the parametric down-converting crystal as a result of parametric down-conversion therein to detect the rate of production of multiphoton states, and controlling the rate of production of one order of multiphoton states in response to the detected rate of production of a different order of multiphoton states.

Thus the invention envisages controlling the rate of one order of multiphoton mode, for instance the four-photon second order mode, by monitoring the intensity of another mode, for instance the first order, two-photon mode. This allows accurate adjustment of the apparatus, for instance accurate adjustment of the spacing between the mirror and the parametric down-converting crystal.

Conveniently the rate of the desired mode may be maximised by maximising the rate of the lower-order mode being monitored.

Another aspect of the invention is the replacement of the half wave plate used for spatial and temporal walk-off compensation with a birefringent optical element. This gives increased accuracy of compensation and thus increases the efficiency of the amplification process. Conveniently the birefringent optical element is a crystal of the same substance and thickness as the parametric down-converting crystal. It may be substituted by another birefringent material which produces a similar delay between the horizontal and vertical photons propagating through it.

### BRIEF DESCRIPTION OF THE DRAWINGS

FIG. 1 is a schematic diagram of apparatus for producing polarisation entangled photon pairs according to the prior art;

FIG. 2 is another prior art example of apparatus for producing polarisation-entangled photon pairs;

FIG. 3 illustrates the dependency of the number of entangled photon pairs produced upon the mirror position in the arrangement of FIG. 2;

FIG. 4 illustrates at a finer scale the dependency of the number of entangled photon pairs produced upon the mirror position in the arrangement of FIG. 2;

FIG. 5 illustrates apparatus for the generation of polarisation-entangled photon states according to a first embodiment of the invention;

FIG. 6 illustrates results from the apparatus of FIG. 5, in particular the generation of two-photon states in FIG. 6a and the generation of four-photon states in FIGS. 6b and c; and

FIGS. 7a and b illustrates respectively two and four-photon interference by plotting the rate of production of two and four-photon states as a function of mirror position at a fine scale.

### DESCRIPTION OF THE PREFERRED EMBODIMENT

An embodiment of the invention is illustrated in FIG. 5. The apparatus is generally similar to the prior art apparatus shown in FIG. 2 and described in the paper by Antia Lamas-Linares et al. mentioned above. However, the half wave plate 2 of the FIG. 2 apparatus is replaced by a two millimeter thick BBO crystal rotated by 90° with the respect to the optical axis of the down-conversion crystal 1. This compensates for the temporal walk-off of the photons. The pump laser is a 120 FS pulsed, frequency doubled, Ti: Sapphire laser operating at 390 nanometers with an 80 megahertz repetition rate. The pump beam L enters the non-linear beta-barium borate (BBO) crystal 1 cut for type-II phase matching. The difference in the round-trip path length of the pump beam and down-converted field is much smaller than the coherence length of the 5 nanometer bandwidth frequency filtered down-converted photons.

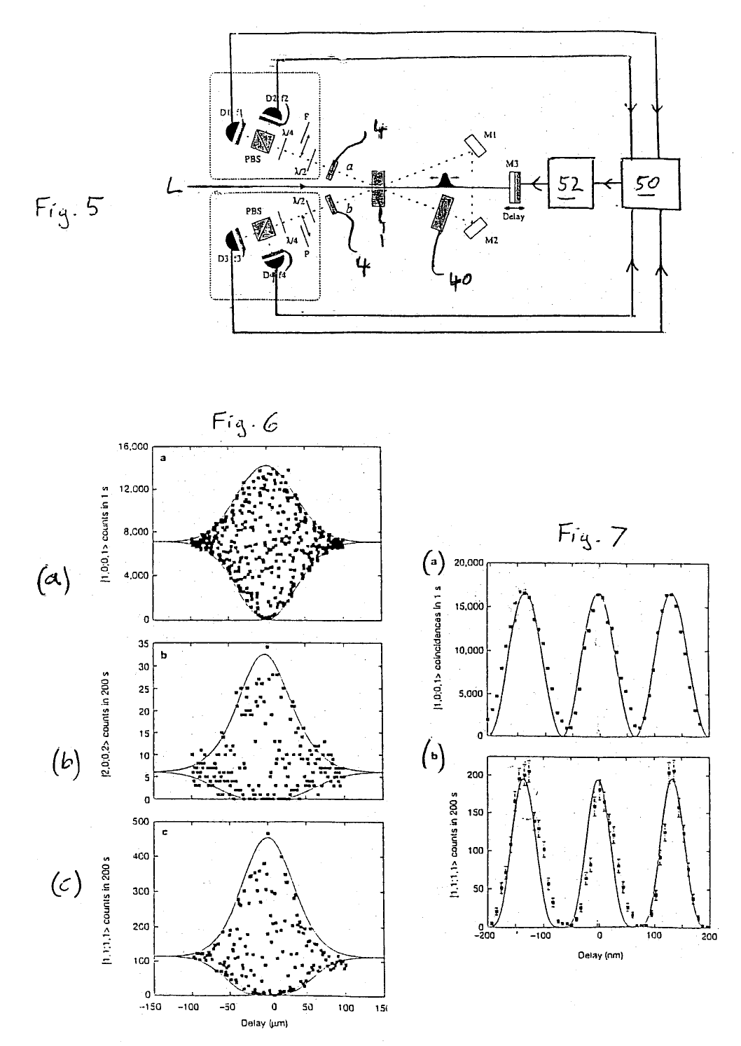

As illustrated, active control of the mirror M3 is provided by feedback from the detector D1 to D4 via a controller 50 and adjuster 52. The detectors D1 to D4 are effective to detect both two and four-photon states. The two-photon, first order state is the most intense and FIG. 6a illustrates the dependency of the rate of production of two-photon states upon the mirror position. It will be seen from FIGS. 6b and c that the rate of production of four-photon states also depends on mirror position in the same way. Therefore in accordance with the present invention the controller 50 monitors the intensity of the two-photon states to provide a control signal which can be used to set the mirror position by adjuster 52. Thus the intensity of the four-photon states can also be controlled, for instance can be maximised by maximising the two-photon signal. FIGS. 7a and b illustrate the two- and four-photon signals are in phase even at a fine scale.

The present invention therefore provides for an enhancement in the amplification process, and in particular for an increase in the number of higher-order photon states produced (with more than two photons).

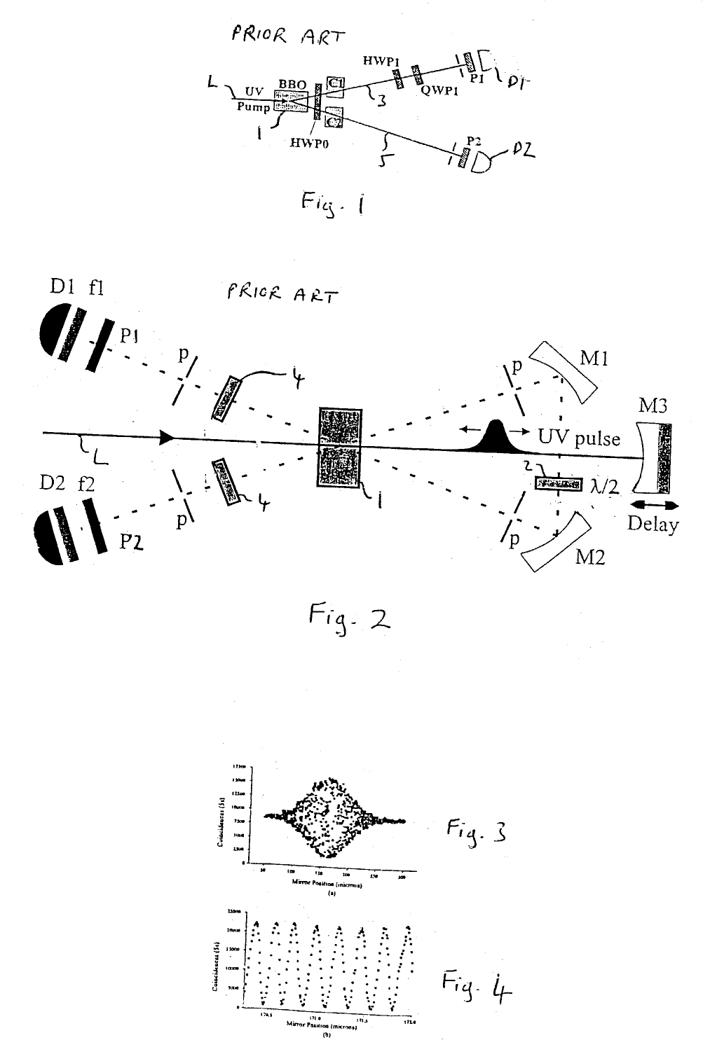

The detector arrangement of D1 to D4 detects the various polarisation states produced in the four photon down-conversion process in a similar way to the detectors used in the prior art arrangements of FIGS. 1 and 2, supplemented by the polarising beam splitters PBS with corresponding additional filters f3 and f4 and half and quarter wave plates to allow detection of the additional states.

What is claimed is:

1. A method of producing a polarisation-entangled multiphoton light field comprising illuminating a parametric down-converting crystal with a pumping light beam, reflecting the down-converted light field back to the parametric down-converting crystal using first reflectors, reflecting the pumping light beam back to the parametric down-converting crystal using a second reflector, detecting multiphoton coincidences in photons emitted from the parametric down-converting crystal as a result of parametric down-conversion therein to detect the rate of production of multiphoton states, and controlling the rate of production of one order of multiphoton states in response to the detected rate of production of a different order of multiphoton states.

2. A method according to claim 1 wherein the rate of production of one order of multiphoton states is controlled by adjusting the spacing between the second reflector and the parametric down-converting crystal.

3. A method according to claim 1 wherein said one order of multiphoton states is second order, four-photon states and said different order is first order, two-photon states.

4. A method according to claim 1 wherein the rate of production of said one order of multiphoton states is maximised by maximising the rate of production of said different order of multiphoton states.

5. A method according to claim 1 further comprising including a birefringent optical element in the path of the down-converted light field between the first reflectors and the parametric down-converting crystal to compensate for propagation differences between different polarisation states of said emitted photons.

6. A method according to claim 5 wherein said birefringent optical element is a crystal of the same substance as said parametric down-converting crystal.

7. A method according to claim 6 wherein said birefringent optical element has the same optical thickness as said parametric down-converting crystal.

8. Apparatus for producing a polarisation-entangled multiphoton light field comprising light source for illuminating a parametric down-converting crystal with a pumping light beam, first reflectors for reflecting the down-converted light field back to the parametric down-converting crystal, a second reflector for reflecting the pumping beam back to the parametric down-converting crystal, detectors for detecting multiphoton coincidences in photons emitted from the parametric down-converting crystal as a result of parametric down-conversion therein to detect the rate of production of multiphoton states, a controller for controlling the rate of production of one order of multiphoton states in response to the detected rate of production of a different order of multiphoton states.

9. Apparatus according to claim 8 wherein the controller produces a control signal in response to which the spacing between the second reflector and the parametric down-converting crystal is adjusted to perform said control of the rate of production of one order of multiphoton states.

10. Apparatus according to claim 8 further comprising an adjuster for adjusting said spacing between the second reflector and the parametric down-converting crystal in response to said control signal.

11. Apparatus according to claim 8 wherein said one order of multiphoton states is second order, four-photon states and said different order is first order, two-photon states.

12. Apparatus according to claim 8 wherein said controller maximises the rate of production of said one order of multiphoton states by maximising the rate of production of said different order of multiphoton states.

13. Apparatus according to claim 8 further comprising a birefringent optical element in the path of the down-converted light field between the first reflectors and the parametric down-converting crystal to compensate for propagation differences between different polarisation states of said emitted photons.

14. Apparatus according to claim 13 wherein said birefringent optical element is a crystal of the same substance as said parametric down-converting crystal.

15. Apparatus according to claim 13 wherein said birefringent optical element has the same optical thickness as said parametric down-converting crystal.
